(19) United States
(12) Patent Application Publication
(10) Pub. No.: US 2015/0329045 A1
(43) Pub. Date: Nov. 19, 2015

(54) VEHCILE DETECTION AND WARNING SYSTEM

(71) Applicant: Fritz B. Harris, ROCKLIN, CA (US)

(72) Inventor: Fritz B. Harris, ROCKLIN, CA (US)

(21) Appl. No.: 14/278,295

(22) Filed: May 15, 2014

(51) Int. Cl. B60Q 9/00; G08G 1/16; H04N 7/18

(52) U.S. Cl. CPC B60Q 9/008; H04N 7/183; G08G 1/166

(57) ABSTRACT

A vehicle warning system, facing rearward, identifies approaching motor vehicles and warns a cyclist that a vehicle is approaching. The system can be configured for either right hand drive or left hand drive roadways. An image capture module provides images of an approaching vehicle and image recognition software confirms a vehicle is approaching, calculates a relative approach speed, and preserves a video file of the encounter on a storage media device. Additional approaches are saved sequentially in “N” number of video files. When “N” number of video files have been recorded, the next approach video overwrites the oldest saved video minimizing video storage but preserving the last “N” encounters. Warning may be communicated to the cyclist by audio, video, or any combination of the two.

### BACKGROUND OF THE INVENTION

Cyclists face risks by sharing roads with other vehicles of considerably larger size, mass, and velocity. Additionally, forward facing cyclists can only know what is approaching from behind them by sound, by turning their heads to look, or using a mirror mounted to their cycle or person (example: helmet mounted mirror). Sound of an approaching vehicle is often not a reliable indicator. Wind and other background noises may mask the vehicle sound. Later model hybrid and electrical vehicles can generate very low operating noise volumes, as can very quiet tire tread profiles. Vehicles thus equipped can overtake cyclist without the cyclist being alerted to their presence. Turning one's head to look adds risk by taking one's attention off what is in front of them and in some cases the head turning movement itself induces input to the cycle steering mechanism causing inadvertent course change (i.e. looking around to the left may cause course change to the left). Cycle mirrors, while providing an image of what is behind, are of necessity small and require repeated viewing to judge whether a vehicle is approaching or receding and if approaching, the relative speed of the approach. Mirrors also require placement on the body, equipment, or cycle that make them vulnerable to maladjustment.

A potential solution to the above mentioned issues would be an apparatus which could identify vehicles approaching from the rear and warn the cyclist of the approaching vehicle prior to the overtake with a minimum amount of disruption to the cyclist attention.

Previous attempts have been made to identify approaching vehicles using cycle mounted radar or ladar (laser radar) transmitting and receiving antenna as documented in U.S. Pat. No. 6,731,202 and research paper “Collision Avoidance Radar for Bicyclist and Runners” by April Johnson, et. al. published by IEEE @ 2010 (print ISBN 978-1-4244-6576-7). U.S. Pat. No. 6,731,202 describes a bicycle mounted radar system to detect an approaching vehicle and alerts the rider of the approaching vehicle. The research paper “Collision Avoidance Radar for Bicyclist and Runners” describes a K-band FMCW monopulse radar module designed for future Intelligent Automotive Cruise Control Applications. The system acquires radar sensor data to obtain range and speed estimates of an approaching object and overlays the information from the radar on a video image.

### SUMMARY OF THE INVENTION

The present invention has been developed to provide a method and/or system using a compact lightweight vehicle detection and warning system mounted on a cycle in a rear facing orientation to detect and warn of an approaching vehicle. The system uses an image capture module with an unobstructed view of what is behind the cycle to provide images to a process control module to identify approaching vehicles and establish their relative closing speeds while warning the cyclist of the coming encounter. A video file showing the encounter is saved to a storage media device.

According to one embodiment of the invention, there is a system for detecting an approaching vehicle and warning a cyclist. The system comprises an image capture module, a process control module, and a wireless module. The image capture module may be configured to capture images of an approaching vehicle and send them to a process control module. The process control module may be configured to confirm an approaching vehicle, estimate the relative speed of the vehicle, and provide an audio, video, or any combination of audio and video warning to a cyclist. The wireless module may be configured to receive the warning from the process control module and transmit the warning to the cyclist. The process control module may further be configured to send at least one record of a video file showing the approaching vehicle to a storage media device. The image capture module may comprise a high definition imaging device and lens system wherein the lens system provides images to the camera that include an area of interest within which a vehicle may be detected. The wireless module may comprise a low power Bluetooth module. The process control module may be coupled to a storage media device, a power source, an on/off module, a start/stop module, a program operating light module, and a power source low/no configuration light module.

According to one embodiment of the invention, there is a method of detecting an approaching vehicle and warning a cyclist of the approaching vehicle. The method may include the step of providing configuration data to a process control module. The method may include configuring the process control module to acquire images from an image capture module. The method may include activating an approach acquisition program to process the images to determine the presence of an approaching vehicle. The method may include estimating the relative approach speed of the approaching vehicle. The method may include transmitting a warning to a cyclist that a vehicle is approaching. The method may include storing a video file of a predetermined size showing the approach of the vehicle.

According to one embodiment of the invention, there is a device for detecting an approaching vehicle and providing a warning to a cyclist. The device includes a process control module that may include a processor, a memory module, a camera interface module, a storage media interface module, a USB interface module, and a LAN controller module. The processor may be configured to receive video images from the image capture module and process them to confirm an approaching vehicle, determine a relative speed of the vehicle, warn a cyclist of the approaching vehicle, and send a video file to a storage media device.

The processor is functionally coupled to a memory module, the memory module configured to store at least one of the following; a configuration file, a system operating program, an approach acquisition program, a transmit audio/video program, and a video storing program. The processor is functionally coupled to the camera interface module, the camera interface module is functionally coupled to an image capture module and configured to receive video images from the image capture module and send the images to the processor.

The processor is functionally coupled to a LAN controller module, the LAN controller module functionally coupled to a wireless module to transmit a warning to a cyclist. The warning may be in the form of video, audio, or any combination of the two.

The processor may be functionally coupled to the storage media interface module, the storage media interface module is configured to receive video files from the processor and send them to a first non-volatile memory device. The processor may be functionally coupled to a USB interface module, the USB interface module configured to communicate with a computation device or a second non-volatile memory device. The process control module may be functionally coupled to an on/off switch module, a start/stop switch module, a program operating light module, and/or a power source low/no configuration light module.

### BRIEF DESCRIPTION OF THE FIGURES

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a module diagram of a vehicle detection and warning system for use by a person traveling along a road, according to one embodiment of the invention.

FIGS. 2-4 illustrate acquisition and tracking of a vehicle on a road using an area of interest, the area of interest being smaller than the overall image.

FIG. 5 is a flow chart illustrating operation of the vehicle acquisition and warning system, according to one embodiment of the invention.

FIG. 6 is a flow chart illustrating an approach acquisition process, according to one embodiment of the invention.

FIG. 7 is a module diagram of a vehicle detection and warning device for use by a person traveling along a road, illustrating internal components of a process control module, according to one embodiment of the invention.

### DETAIL DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Any of the functions, features, benefits, structures, and etc. described herein may be embodied in one or more modules. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, cyclist interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like. Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

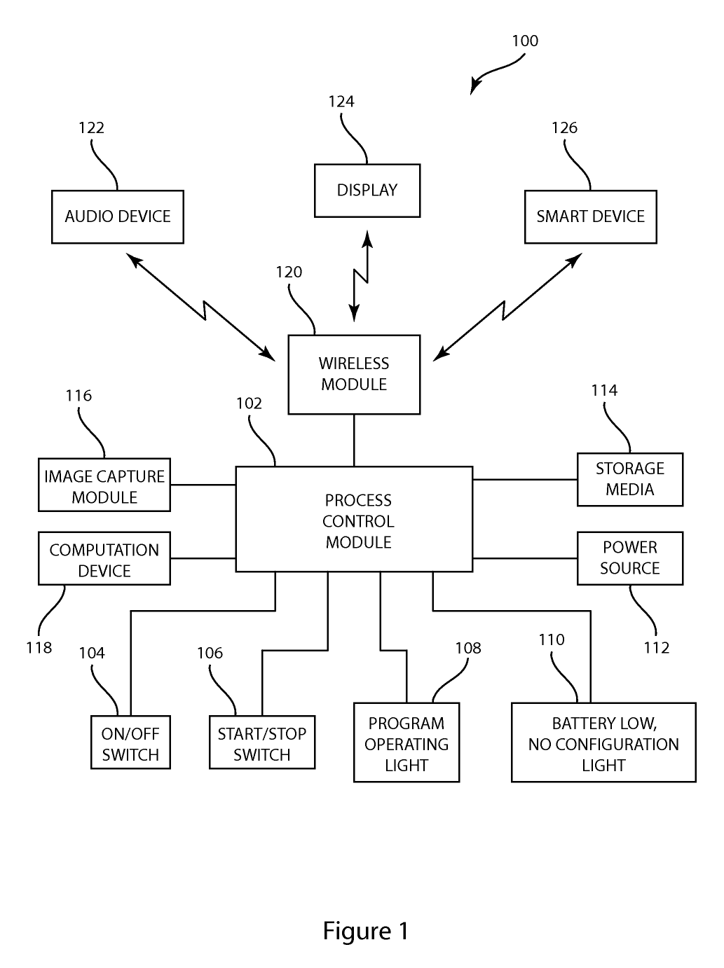

FIG. 1 is a module diagram of a vehicle detection and warning system for use by a person traveling along a road, according to one embodiment of the invention. There is shown a process control module functionally coupled to each of a wireless module, a storage media device, a power source, an image capture device (e.g. an image capture module/system, or a charge-coupled device sensor (CCD sensor)), on/off switch module, start/stop switch module, program operating light module, and power source low/no configuration light module. Accordingly, the system may be used to detect the approach of a vehicle, warn a cyclist of the approaching vehicle, and store a predetermined number of video recordings of different approaching vehicles.

The illustrated process control module is configured to receive video images from the image capture module, process the images and warn the cyclist of an approaching vehicle, and provide storage of a video recording showing an approaching vehicle. As a non-limiting example, there may be a processor configured to process images to detect the presence of a vehicle within an area of interest of the image and determine a relative vehicle speed, and provide warnings to the cyclist as visual, or audio, or a combination of two warnings. The process control module may include a processor and/or may be associated with a processor, processor module, processing device/system or the like, a camera interface module, LAN controller module, storage media interface module, and a USB interface module.

The illustrated computation device is functionally coupled to the process control module and configured to create a configuration file and communicate the file to the process control module. Configuration file may include but is not limited to the date, time, right hand or left hand drive roadway, and a calibration factor. The computation device may be a personal computer, tablet, smart phone, or other such device that may be connected to the process control module via the USB interface module or wireless module. The computation device may be configured to receive video recordings of different approaching vehicles.

The illustrated image capture module is functionally coupled to the process control module and configured to send video images to the processor. The image capture module is designed to image a portion of the roadway to a distance sufficient that a cyclist is given an adequate warning time before an approaching vehicle reaches the cyclist. The image capture module may comprise a high definition CCD imaging device, for example a CCD sensor capable of high definition video, and a custom designed lens system. In addition, the image capture module may be calibrated. A calibration value may be used to determine the relative speed of the vehicle based on the increase of the number of pixels representing a vehicle measured between two video frames spaced by some time period.

The illustrated wireless module is functionally coupled to the process control module and configured to transmit audio, video images, or any combination of the two. Any number of wireless transmission technologies may be used and include but not limited to WiFi, cellular (i.e.—GSM/EDGE, UMTS/HSPA, CDMA, LTE, etc.), ZigBEE, or Bluetooth. In one embodiment according to the invention the wireless module comprises a low power Bluetooth device to transmit to any number of devices including but not limited to an audio device such as earphones, a display, or smart devices such as a smart phone or a tablet.

The illustrated storage media device is functionally coupled to the process control module and configured to store video recordings of a predetermined sized and quantity. The video recordings each store the approach of a vehicle and when the quantity of stored video recordings approaches reaches a predetermined number the next recorded approach overwrites the oldest recording saved on the storage media device. The storage media device is non-volatile memory device. Examples of non-volatile storage media devices comprise a removable flash memory card such as an SD card or Compact Flash card, or a removable flash drive.

The illustrated power source is functionally coupled to the process control module and may comprise an embedded battery, a removable battery, or other such power source. In one embodiment the power source is rechargeable and may be charged via the USB interface module using an external charging source, or may be removed from the system for recharging.

The vehicle detection and warning system 100 may include an image capture module 116, a process control module 102, storage media device 114, a computation device 118 (i.e.—personal computer, tablet, smart phone, etc.), a power source 112, a wireless transmission module 120, an on/off switch module 104, a start/stop switch module 106, and two indicator lights, one green program operating light module 108 and one red power source low/no configuration light module 110. The image capture module 116 is functionally coupled to the process control module 102, the image capture module 116 comprises a high definition (HD) image sensor and lens system and sends high definition video frames to the process control module 102. Storage media device 114 is functionally coupled to the process control module 102 and receives recorded video files for storage. The wireless module, which may comprise transmission and reception capabilities, 120 is functionally coupled to the process control module 102. The computation device 118 is functionally coupled to the process control module 102, the computation device 118 capable of creating a configuration file. Additional devices not shown include camera/electronics housing, and mounting hardware used in mounting the vehicle detection and warning system to a cycle or other vehicle ridden by a cyclist.

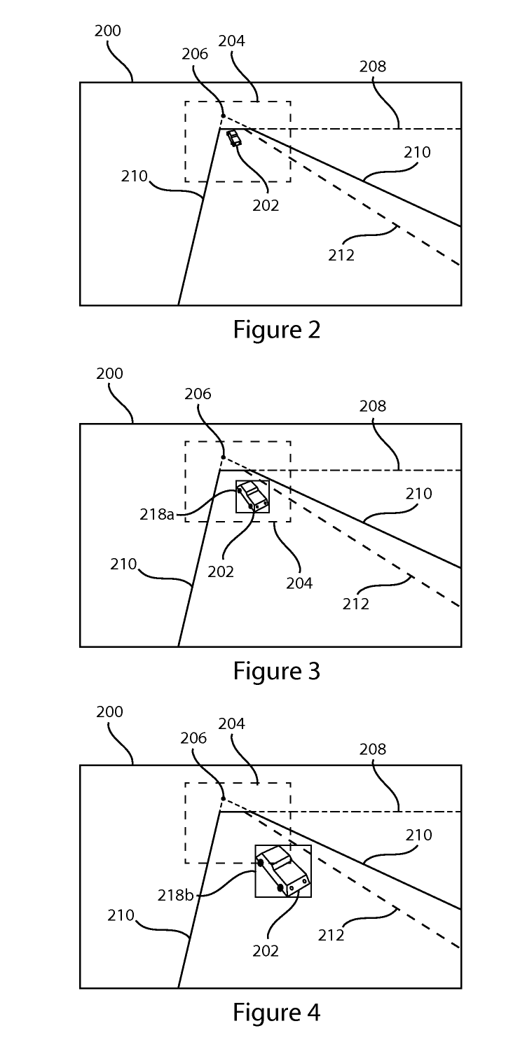

FIGS. 2-4 illustrate acquisition and tracking of a vehicle on a road using an area of interest 204, the area of interest 204 being smaller than the image frame 200. To search an entire image frame 200 for an approaching vehicle requires a great deal of time and processing power. However, by establishing a distance from the image capture module to the point of initial intercept (PII), as defined by the design of the optics of the image capture module, the image sensor, and the height of the detection and warning system off the ground, a predetermined area of interest may be established by imaging many different road terrains. A vanishing point 206 and horizon line 208 are determined using edge detection routines. Edge detection routine finds the two edges of the roadway 210 and projects them to a vanishing point 206. The area of interest 204 is designed to cover an area large enough to always include the vanishing point and horizon line for all cycle orientations and road terrains. Many tests are run having different scenarios of cyclist and road conditions and an area of interest determined for each scenario. From these tests, a final area of interest is computed that covers all vanishing points and horizon lines for all the test scenarios. Thus the area of interest is pre-determined and remains a fixed size within the image capture area. The area of interest will shift from the left side of the image for right roadway operation to the right side of the image for left roadway operation and is dependent on which road side (right or left) is selected in the configuration file.

FIG. 2a depicts acquisition of the object of interest 202 (i.e., a vehicle) within the area of interest 204. A Haar feature-based cascade classifier (HCC) is used to detect the object of interest 202. Haar feature-based cascade classifiers are described in a paper by P. Viola and M. Jones, “Rapid object detection using a boosted cascade of simple features”, Computer Vision and Pattern Recognition, 2001, Proceedings of the 2001 IEEE Computer Society Conference, vol. 1 (2001), pp I-511 through I-518 (URL: http://ieeexplore.ieee.org/xpl/login.jsp?tp=&arnumber=990517&url=http%3A%2F%2Fieeexplore.ieee.org%2Fxpls%2Fabs_all.jsp%3Farnumber%3D990517). Software modules have been developed by OpenCV, an open source community, to implement a Haar feature-based cascade classifier. OpenCV (Open Source Computer Vision Library) is an open source computer vision and machine learning software library and can be found at http//opencv.org.

First, a classifier is trained with sample views of an object of interest (i.e., many types of vehicles), called positive examples, that are scaled to the same size, and negative examples, the negative examples being arbitrary images not including an object of interest having the same size. Initially, the algorithm needs numerous positive images (images of vehicles) and negative images (images without vehicles) to train the classifier. After a classifier is trained, it is applied to the area of interest 206 to detect an object of interest 202.

FIG. 3 illustrates an area of interest 206 wherein an object of interest 202 is confirmed to be within the area of interest 202 according to one embodiment of the invention. The analysis is performed on a frame by frame methodology with each frame having a timestamp allowing time between any two frames to be calculated. A first frame is grabbed from the image capture module 116 and the area of interest 204 within the first frame is scanned for an object of interest 202. Any potential objects of interest 202 detected and confirmed to be within the area of interest 204 are cropped by an area 218a, the cropped area 218a being smaller than the area of interest 204. The cropped area 218 is processed to find key features of the object of interest 204 to identify it as a specific vehicle. Key features of the object image are determined by the Haar feature-based cascade classifier and compared against the key features of the any like object of interest 202 found in a subsequent frame grabbed from the image capture module 116. This helps to weed out false positives that may come and go from frame to frame. It also allows the correlating of vehicle images from one frame to vehicle images in a subsequent frame so as to track each vehicle. With a vehicle approach being acquired and confirmed the relative speed of the vehicle is estimated. An image that grows in size indicates a direction towards the camera. A shrinking image indicates a direction away from the camera, in which case that image would no longer be tracked.

Once it's established that a vehicle is approaching (the acquired vehicle is increasing in size), estimated distance traveled is determined using a pre-determined calibration factor and then relative speed is calculated using the time period between frames and the distance traveled. Pixel expansion rate is dependent on the lens system design and focal length of the image capture module. Therefore, a calibration factor lookup table is created that contains calibration factors for the image capture module 116. Alternatively, other methods of determining the distance traveled may be used and comprise: a) developing a formula that takes the pixel expansion rate as an input, or b) using temporal parallax methods to calculate the relative distance traveled. Video images of a vehicle traveling at a known speed, as measured by a radar gun in close proximity to an image capture module, are captured by the image capture module. The number of pixels contained within an area 218 is determined for a first frame (area 218a) and a second frame (218b), the frames are not necessarily consecutive frames. The time period between the two frames is calculated using the timestamps saved with each frame. An expansion ratio, a ratio of the pixels contained within area 218b from the second frame and the number of pixels contained within area 218a from the first frame, is calculated. Finally, a calibration factor for each measured speed is calculated by first multiplying the measured speed by the calculated time period and then dividing the result by the expansion ratio. The calibration lookup table is created comprising multiple pairs of expansion ratios and calibration factors wherein each pair is related to a different measured speed. This pre-determined lookup table is stored within the process control module. The same calibration factor lookup table is used regardless of which side of the road the system is configured to operate.

As seen in FIGS. 3 and 4 the size of the object of interest 202 increases and thus the number of pixels contained within the object of interest 202 increases. A cropped area 218 surrounding the object of interest 202 is determined, the area being smaller than the area of interest 202. The number of pixels that make up the object of interest 202 in a first frame and the number of pixels that make up the object of interest 202 in a second frame are determined by scanning the cropped images. A ratio representing the increase in the number of pixels between the two frames is calculated. The calculated ratio is compared to the expansion ratios stored in the lookup table and the expansion ratio in the lookup table that is closest to the calculated expansion ratio is retrieved from the lookup table. Estimated distance traveled by the object of interest 202 is calculated by multiplying the calculated expansion ratio value by the retrieved calibration value. The timestamps on the first and second frames are used to calculate the time period between the two frames. Relative speed is calculated using the calculated distance traveled divided by the calculated time period.

For a cyclist traveling in one direction, the vehicle image expansion direction relative to the total image as the vehicle approaches the cyclist will be different depending on whether the cyclist is traveling on the right side of the road (image expansion to the cyclist left, but rear facing cameras right) or the left side of the road (image expansion to the cyclist right, but rear facing cameras left). The device's configuration program allows the choice of the predominant side of the road to be ridden to be made by the rider (i.e. USA—Right, UK—Left). Likewise, the tracking of the expanding vehicle image can be anticipated by the configuration setting.

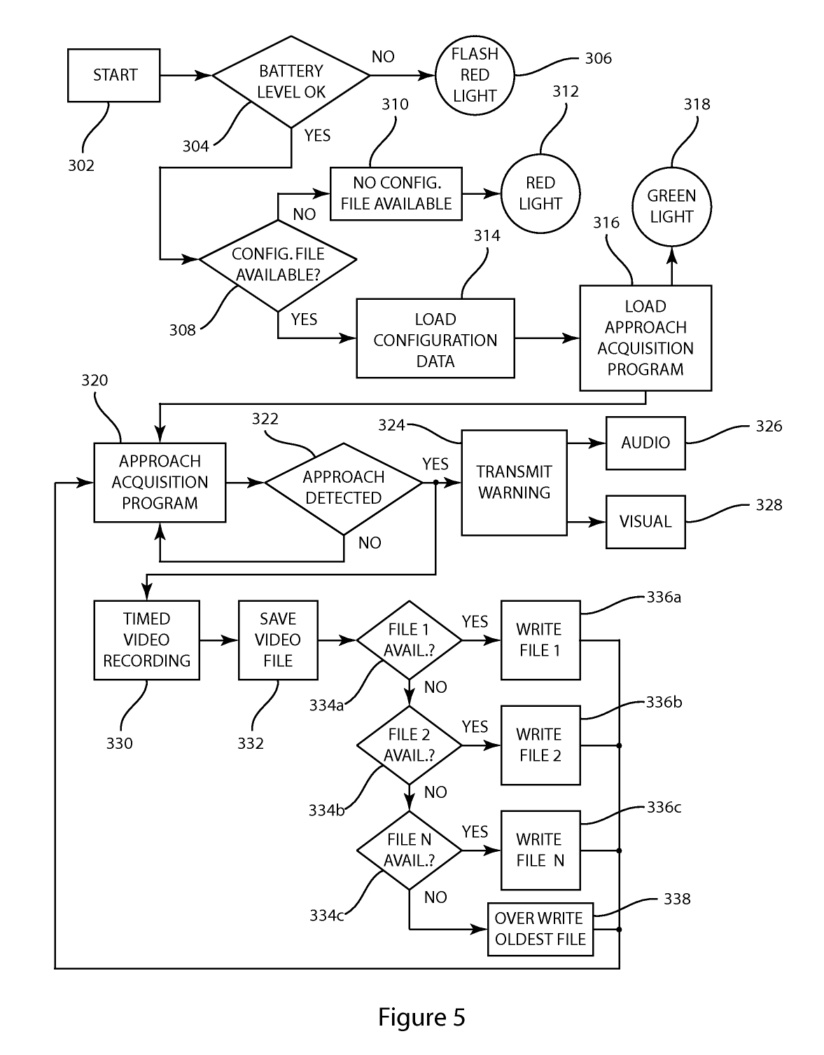

FIG. 5 is a flow chart illustrating operation of the vehicle acquisition and warning system, according to one embodiment of the invention. Before the operation of the system may commence a configuration file is created comprising current time, date, and/or right hand or left hand drive roadway. The configuration file may also include a calibration file used to estimate a vehicle's speed. Upon completion, the configuration file is saved to the process control module 102.

Once the configuration file is saved to the system the user can start 302 the operation of the vehicle acquisition and warning system. The first step checks the power source charge level 304, if the charge level is insufficient the red light 110 emits a flashing red light 306. The power source must be charged, if rechargeable, or replaced before further operation may continue. If the charge level is sufficient the system checks the availability of a configuration file 308. If a configuration file is not found 310 then red light 110 emits a steady red light 312. If the configuration file is found, the configuration data is loaded 314. Then the approach acquisition program is loaded 316 and green light 108 emits a steady green light 318 for several seconds indicating the program is running and ready for use. The approach acquisition program 320 is started, the green light 108 is activated and remains on, the image capture module 116 turns on, and the approach acquisition program 302 begins searching the area of interest 206 for an object of interest 202.

Once an approaching object of interest is detected 322 several actions occur. A transmit warning 324 signal triggers a warning to be sent to the cyclist. The trigger signal is configured to cause an audio/video signal to play on a remote device or any combinations thereof.

With the warning having been initiated and transmitted, the system begins a timed video recording 330 from the image capture module output. In addition to the video recording, a time and date stamp along with the stored configuration data are saved in a video file. Save video file step 332 checks memory to see which image file was last saved to memory wherein memory may be the memory module, a removable memory device, a flash drive, or other non-volatile memory device. If image file 1 334a has not been stored the write file step 1 336a saves image file 1 to the memory device. To minimize required digital data storage capacity, additional vehicle approaches are saved sequentially in “N” number of video files, the number of files “N” is predetermined. When “N” number of video files have been recorded, the next approach video file overwrites the oldest saved video 328. This minimizes video storage but preserves the last “N” encounters. The video files of the overtaking event are available for future recall as necessary. Upon initiating timed saving of camera video output, the software returns to the approach acquisition program step 320. The program can be stopped at any time by pressing the start/stop switch module 106 and the device can be turned off by pressing the on/off switch module 104.

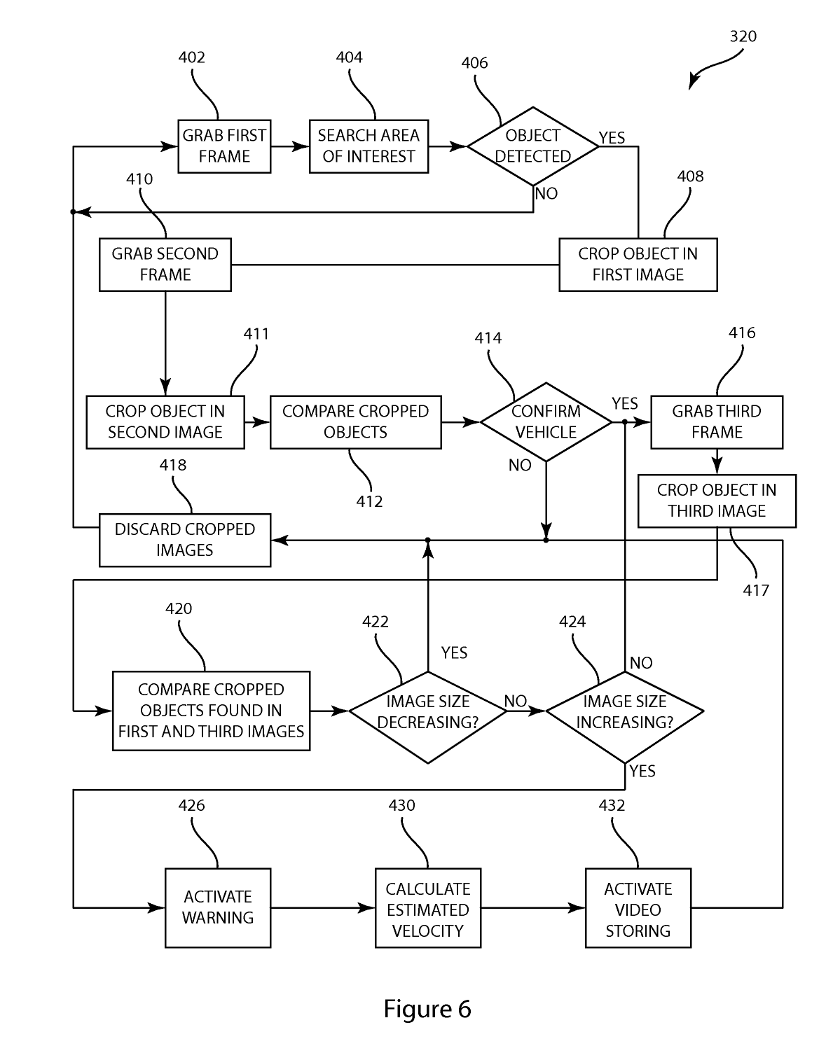

FIG. 6 is a flow chart depicting approach acquisition process 320, according to one embodiment of the invention. The first step in the approach acquisition program 320 begins by grabbing a first frame 402 from the image capture module 116. An area of interest 206 is searched 404 for an object of interest 202. If an object of interest 202 is not found the method loops back and grabs another first frame 402. If an object of interest 202 is detected the object of interest 202 is cropped to an area 408 that contains the object of interest 202. A second frame is grabbed 410 and then the program crops an area 411 that contains the object of interest found in the second frame. The cropped object from the first frame and the cropped object from the second frame are compared 412. If a vehicle is not confirmed as being the same object in both frames then the cropped images are discarded 418 and the method loops back to the beginning where another first frame is grabbed 402. Once an object of interest is confirmed 414 a third image frame is grabbed 416 and the object of interest found in the third image frame is cropped 417. The cropped first object from the first image and the cropped object found in the third grabbed image are compared 420. A determination is then made as to whether the object of interest 202 is decreasing in size 422. If the object of interest 202 is decreasing in size the images are discarded 418 and the program loops back to grab a first frame 402. If the object of interest 202 is not decreasing in size the program then checks to seeing if the image size is increasing 424. If the object of interest 202 is not increasing, also not decreasing, then the program loops back and grabs another third frame 416 and the process continues. Once it is determined that the object of interest 202 is increasing in size a warning is activated 426, the relative approach speed is calculated 430, and video recording and video file storage is activated 432. Once a warning is sent and video file storage has been activated the program loops back to the discard cropped images 418 step and the program continues by grabbing a new first frame 402.

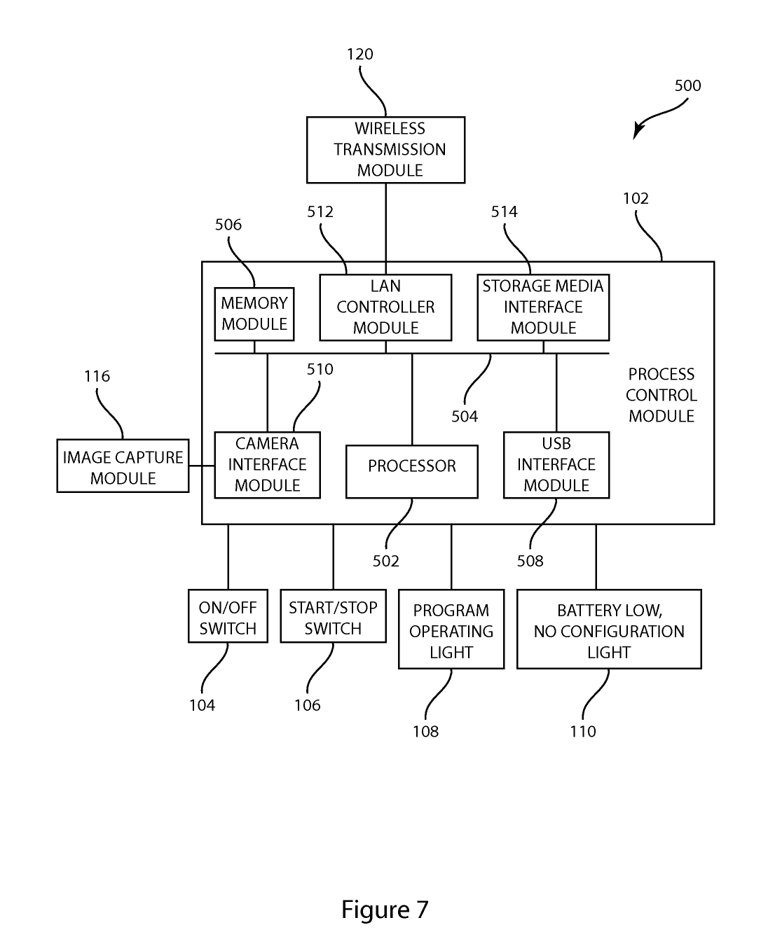

FIG. 7 is a module diagram of a vehicle detection and warning device for use by a person traveling along a road, according to one embodiment of the invention. The device may be mounted to the seat post wherein the optical axis of the image capture is aligned such that the image capture module views the roadway to the rear of the cycle and the optical axis is in line with the cycle frame. The vehicle detection and warning device comprises a process control module, a wireless module, an image capture module, and may include an on/off switch module, a start/stop switch module, a program operating light module, and a power source low/no configuration light module. In use the device provides a warning to a person that a vehicle is approaching from the rear and saves a video recording of the event. The illustrated processor may include one or more processing devices such as those found in common electronic devices (computer, servers, tablets, smartphones, etc.).

The illustrated storage media interface module allows memory devices that may include one or more non-volatile memory devices to connect to the process control module. Hard drives, flash drives, and removable flash memory such as an SD card, are non-limiting examples of such. The memory device may be functionally coupled to the storage media interface module, the storage media interface module being functionally coupled to the processor via a communication bus.

The illustrated image capture module is functionally coupled to the camera interface module, the camera interface module being functionally coupled to the processor via a communication bus. The image capture module may comprise a high definition (HD) CCD imaging sensor and is optically aligned to a lens system such that it captures an area to the rear of the cyclist to include the vanishing point, horizon line, and the PII.

The illustrated on/off switch module, a start/stop switch module, a program operating light module, and a power source low/no configuration light module may be functionally coupled to the process control module to provide the cyclist the ability to turn the power to the device on and off, to start and stop the approach acquisition program, and provide visual indicators for program operation, power source low condition, and no configuration file found.

The wireless module is functionally coupled to the process control module via a LAN controller module, the LAN controller module functionally coupled to the processor via a communication bus. A low power Bluetooth transmitter is a non-limiting example of such a wireless module.

A hardline interface module represented by the USB interface module is functionally coupled to the processor the communication bus. The USB interface module may connect the process control module to a computational device such a personal computer, tablet, smart phone or other such device to receive a configuration file and other predetermined data to properly configure the vehicle detection and warning device. A non-volatile memory device may be coupled to the process control module via the USB interface module to store video files.

The illustrated memory module is functionally coupled to and in communication with the processor via the communication bus. The memory module may store at least one program controlling the operation of the vehicle detection and warning device, a configuration file, and a calibration file for the image capture module.

According to one embodiment of the invention there is a vehicle detection and warning device 500 configured to receive and process images, provide one or more warnings of an approaching vehicle, and store a predetermined number video files of approaching vehicles in a media storage device. A process control module 102 is functionally coupled to a wireless module 120 and an image capture module 116. The process control module 102 may be functionally coupled to an on/off switch module 104, a start/stop switch module 106, a program operating light module 108, and a power source low/no configuration light module 110.

The process control module 102 may include a memory module 506, a LAN controller module 512, a storage media interface module 514, a camera interface module 510, a processor 502, and USB interface module 508. The wireless module 120 is functionally coupled to the LAN controller module 512 and the LAN controller module 512 is coupled to the processor 502 via a communication bus 504. The LAN controller module 512 is configured to communicate warning information from the process control module 102 to the wireless module 120, the wireless module 120 configured to transmit information to a variety of devices including but not limited to a speaker, a display, a smart device such as a tablet, smart phone or other such devices.

A camera interface module 510 is functionally coupled to the processor 502 via the communication bus 504 and to an image capture module 116. The camera interface module 510 is configured to receive video images from the image capture module 116 and send them to the processor 502 via the communication bus 504.

A USB interface module 508 is functionally coupled to the processor 502 via the communication bus 504, the USB interface module 508 is configured to send and receive data between the USB interface module 508 and the processor 502. The USB interface module may be functionally coupled to external devices such a personal computer, a tablet, a smart phone, external memory devices, or other such devices.

The on/off switch module 104 may be functionally couple to the process control module 102 and turns power to the vehicle detection and warning device 500. The start/start switch module 106 may be functionally coupled to the process control module 102 and activates/deactivates the approach acquisition program 320. A program operating light module 108 may be functionally coupled to the process control module 102 and visually indicates when the vehicle detection and warning device 500 is operating properly. A power source low/no configuration light module 110 may be functionally coupled to the process control module 102 and visually indicates when the power source charge is to low and when there is no configuration file loaded in the process control module 102.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the above discussion describes particular uses for such systems, methods and etc., it is understood that the applications are plethoric and in some cases unknowable at this point.

Additionally, although the figures illustrate specific connections, relationships, and sequences, it is understood that the plethoric connections, relationships and sequences not described by but also not contraindicated by the claims are envisioned and may be implemented in one or more non-limiting embodiments of the invention.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

I claim:

1. A system to detect an approaching vehicle and provide a warning to a cyclist, comprising:
a. an image capture module functionally coupled to a process control module, the image capture module configured to capture images of an approaching vehicle;
b. a process control module, including a processor, configured to receive images from the image capture module, confirm the presence of an approaching vehicle within an area of interest in the image, estimate the relative speed of the approaching vehicle, automatically generate a warning signal based on a trigger associated with information regarding an approaching vehicle, store a record of a video file; and,
c. a wireless transmission module functionally coupled to the process control module and configured to transmit the generated warning signal to a remote media device.

2. The system of claim 1, further comprising a storage media device functionally coupled to the process control module, the storage media device configured to receive and store at least one record of a video file.

3. The system of claim 1, further comprising an on/off module, a start/stop module, a program operation light module, and a power source low/no configuration light module each functionally coupled to the process control module.

4. The system of claim 1, wherein the image capture module further comprises a high definition imaging device and a lens system functionally coupled thereto.

5. The system of claim 1, wherein the wireless transmission module comprises a low power Bluetooth module.

6. A method for providing a cyclist a warning of an approaching vehicle using a computing device, comprising the steps of:
a. providing a process control module, the process control module including a processor;
b. providing an image capture module functionally coupled to the process control module;
c. processing images from the image capture module to determine the presence of an approaching vehicle;
d. processing a series of images of an approaching vehicle and thereby determining a relative approach speed of the approaching vehicle;
e. automatically generating a warning signal in response to a trigger associated with the presence of an approaching vehicle;
f. transmitting the warning signal to a remote media device; and
g. storing a video file showing the approaching vehicle.

7. The method of claim 6, further comprising the step of providing a configuration module which includes user selectable configuration settings including at least one of the settings comprising: date, times, and right or left side roadway driving.

8. The method of claim 7, wherein the step of processing a series of images to estimate approach velocity further comprises using calibration data for the image capture module to estimate distance traveled by the approaching vehicle.

9. The method of claim 6, further comprising the step of configuring the process control module for a left or right hand roadway.

10. The method of claim 8, wherein the step of determining the relative approach speed further comprises determining a time period, determining a pixel expansion ratio, retrieving an image capture module calibration factor that correlates to the pixel expansion ratio, and multiplying the calibration factor and pixel expansion ratio to form a distance traveled estimate and then dividing the distance traveled estimate by the time period.

11. The method of claim 6, wherein the step of transmitting a warning signal comprises transmitting a media file including at least one component selected from the group of components consisting of audio and video.

12. The method of claim 6, wherein the step of storing a video file comprises storing the file to a removable non-volatile storage media device.

13. The method of claim 6, wherein the step of storing a video file comprises storing the file to a removable flash drive.

14. A device for detecting an approaching vehicle and providing a warning to a cyclist, comprising:
a. a process control module, comprising a processor, a camera interface module, and a LAN controller module, the process control module configured to receive video images and process the images to confirm an approaching vehicle, determine the relative speed of the approaching vehicle, provide a warning to a cyclist, and store a video file showing the approaching vehicle;
b. a memory module functionally coupled to the processor, including a non-transitory data storage device and configured to store configuration data, and programs comprising a system operating program, an approach acquisition program, a transmit audio/video program, and a video storing program;
c. an image capture module functionally coupled to the camera interface module, the interface configured to receive images from the image capture module and send the images to the processor via the camera interface module;
d. a wireless transmission module functionally coupled to the LAN controller module, the LAN controller module functionally coupled to the processor, the wireless transmission module configured to receive warnings from the processor and transmit the warnings externally;
e. a storage media interface module functionally coupled to the processor, the storage media interface module configured to receive a video file from the processor and send the video file to a first storage media device; and,
f. a hardline interface module functionally coupled to the processor, the hardline interface module configured to communicate externally over a physical connection.

15. The device of claim 14, wherein the image capture module further comprises a high definition imaging device and lens system functionally coupled thereto.

16. The device of claim 14, wherein the wireless transmission module comprises a low power Bluetooth module.

17. The device claim of 14, wherein the hardline interface module comprises a USB interface module.

18. The device of claim 14, wherein the memory module is further configured to store the record of a video file showing the approach of the vehicle.

19. The device of claim 14, wherein the memory module is further configured to store image capture module calibration factors.
